(19) United States
(12) Patent Application Publication
(10) Pub. No.: US 2017/0184151 A1
(43) Pub. Date: Jun. 29, 2017

(54) SYNCHRONISING SLIDING RAIL ASSEMBLY

(71) Applicant: Nan Juen International Co., Ltd., New Taipei City (TW)

(72) Inventor: Kuo-Sheng HUANG, New Taipei City (TW)

(21) Appl. No.: 14/981,255

(22) Filed: Dec. 28, 2015

(51) Int. Cl. F16C 33/30; A47B 88/08; A47B 88/12; F16C 29/00; F16C 29/04

(52) U.S. Cl. CPC F16C 33/306; F16C 29/008; F16C 29/043; A47B 88/12; A47B 88/08; F16C 2314/72

(57) ABSTRACT

A synchronizing sliding rail assembly includes a transmission mechanism including a first gear meshed between a first toothed rack of a first inner rail of a first sliding rail unit and a second toothed rack of a first outer rail and a second gear meshed between a third toothed rack of a second inner rail of a second sliding rail unit and a fourth toothed rack of a second outer rail, and a transmission rod coupled between a first transmission member that carries the first gear and a second transmission member that carries the second gear, and thus, the first sliding rail unit and the second sliding rail unit are synchronously moved to carry a drawer accurately between an open position and a close position upon operation of the transmission mechanism.

### BACKGROUND OF THE INVENTION

### 1. Field of the Invention

The present invention relates to sliding rail technology and more particularly, to a synchronizing sliding rail assembly, which enables the inner and intermediate rail of each sliding rail assembly to be moved synchronously and, which uses a transmission mechanism to let the two sliding rail assemblies be synchronously moved so that the two sliding rail assemblies can be smoothly opened or closed and their lifespan can be prolonged.

### 2. Description of the Related Art

In a drawer cabinet, each drawer has two sliding rail assemblies mounted at two opposite lateral sides thereof to facilitate stable sliding movement. When a user pulls or pushes the drawer, if the force is not applied to the middle part of the drawer between the two sliding rail assemblies, or there is a big clearance between the drawer and the cabinet, the applied force will not be envenly distributed to let the drawer not be fully opened or closed, resulting in inclination of the drawer.

Further, a sliding rail assembly for this application generally consists of an outer rail, an intermediate rail and an inner rail. The drawer is affixed to the inner rails of the two sliding rail assemblies, When the user pulls or pushes the drawer, the inner rails will be firstly moved by the drawer, and the inermediate rails will than be moved by the respective inner rails after the inner rails have been moved to the limit. During operation, the two sliding rails can receive force unevenly, lowering sliding stability.

### SUMMARY OF THE INVENTION

The present invention has been accomplished under the circumstances in view. It is therefore the main object of the present invention to provide a synchronizing sliding rail assembly, which uses a transmission mechanism to coupled two sliding rail units, enabling the two sliding rail units to be syunchronously and stably moved when the drawer fastened to the two sliding rail units is being opened or closed.

It is another object of the present invention to provide a synchronizing sliding rail assembly, which uses transmission members of the transmission mechanism to let the inner and intermediate sliding rails to work synchronously, avoiding uneven distribution of applied force through the two sliding rails to shorten the lifespan of the sliding rails.

To achieve this and other objects of the present invention, a synchronizing sliding rail assembly comprises a first sliding rail unit, a second sliding rail unit and a transmission mechanism. The first sliding rail unit comprises a first intermediate rail, a first inner rail coupled to the top side of the first intermediate rail, and a first outer rail coupled to the opposing bottom side of the first intermediate rail. Further, a first toothed rack and a second toothed rack are respectively mounted at the first inner rail and the first outer rail at one side side. The second sliding rail unit comprises a second intermediate rail, a second inner rail coupled to the top side of the second intermediate rail, and a second outer rail coupled to the opposing bottom side of the second intermediate rail. Further, a third toothed rack and a fourth toothed rack are respectively mounted at the second inner rail and the second outer rail at one same side. The transmission mechanism comprises a first transmission member, a second transmission member, and a transmission rod. The first transmission member comprises a first gear pivotally connected to the first intermediate rail and meshed between the first toothed rack and the second toothed rack, and a first connection block located at one side of the first gear. The second transmission member comprises a second gear pivotally connected to the second intermediate rail and meshed between the third toothed rack and the fourth toothed rack, and a second connection block located at one side of the second gear. The transmission rod has two opposite ends thereof respectively connected to the first connection block and the second connection block.

Thus, when the drawer that is fastened to the first inner rail and the second inner rail is being moved, the first sliding rail unit and the second sliding rail unit will be synchronously and stably moved, and the inner and outer sliding rails of each sliding rail unit will be moved synchronously, enabling the two sliding rails to receive force evenly, and thus, the lifespan of the two sliding rails can be prolonged.

### BRIEF DESCRIPTION OF THE DRAWINGS

FIG. 1 is an oblique top elevational view of a first sliding rail unit of a synchronizing sliding rail assembly in accordance with the present invention.

FIG. 2 is an oblique top elevational view of a second sliding rail unit of the synchronizing sliding rail assembly in accordance with the present invention.

FIG. 3 is an exploded view of the synchronizing sliding rail assembly in accordance with the present invention.

FIG. 4 corresponds to FIG. 3 when viewed from another angle.

FIG. 5 is a sectional view of the first sliding rail unit and the first transmission member.

FIG. 6 is a sectional view of the second sliding rail unit and the second transmission member.

FIG. 7 is a schematic top view illustrating a status of the synchronizing sliding rail assembly during an opening operation of the drawer.

FIG. 8 is a schematic side view illustrating an operating status of the first sliding rail unit during an opening operation of the drawer.

FIG. 9 is a schematic side view illustrating an operating status of the second sliding rail unit during an opening operation of the drawer.

### DETAILED DESCRIPTION OF THE PREFERRED EMBODIMENT

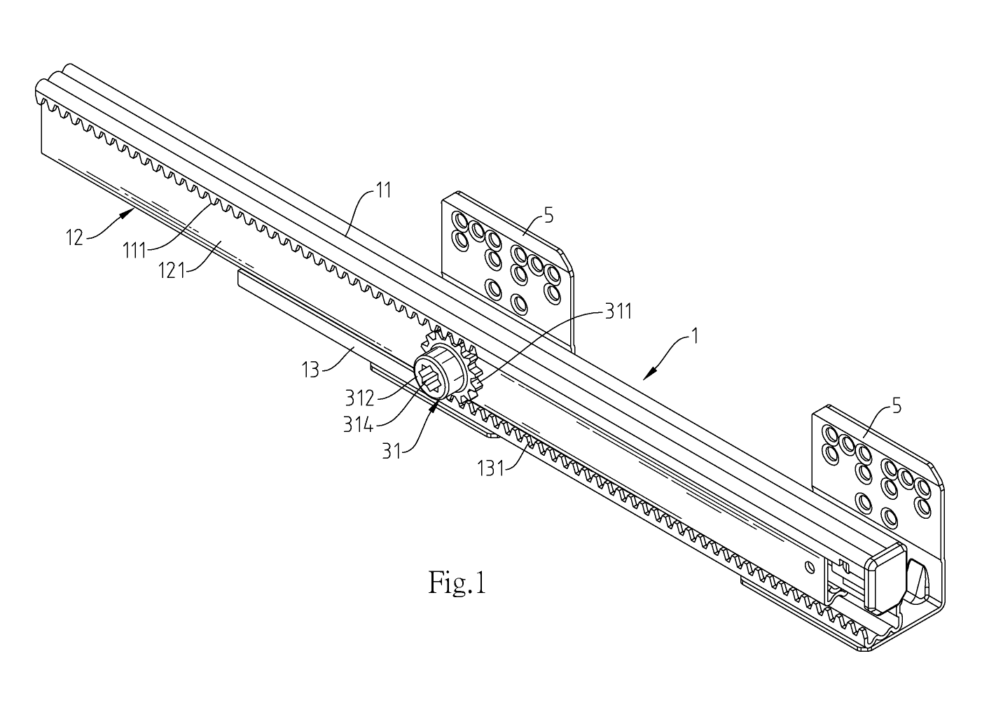

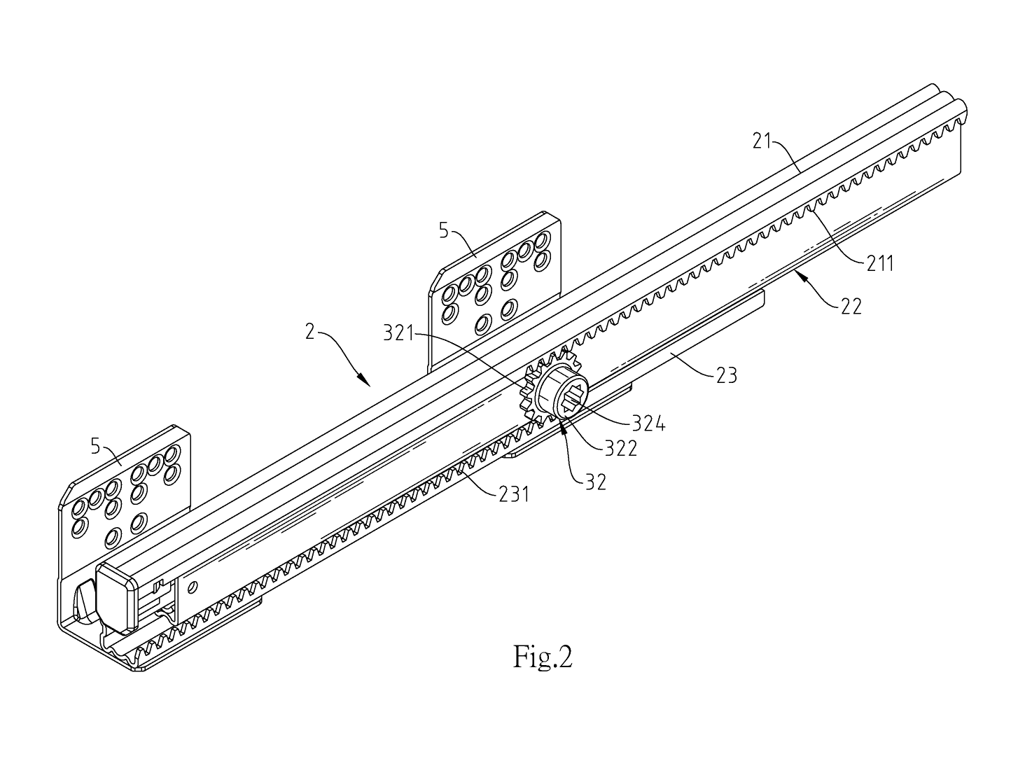

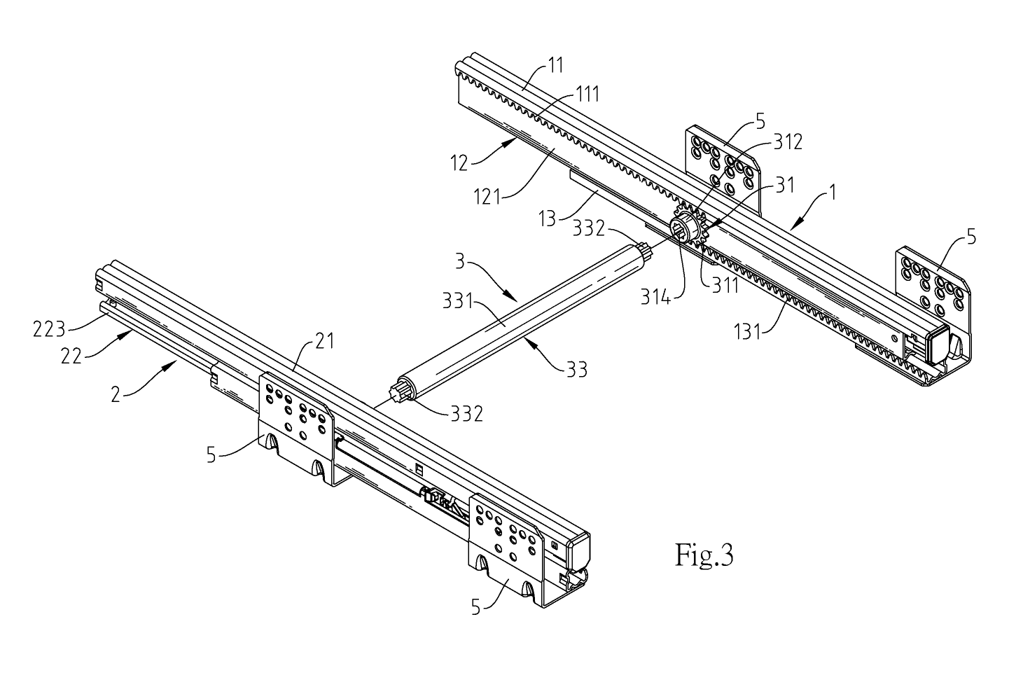

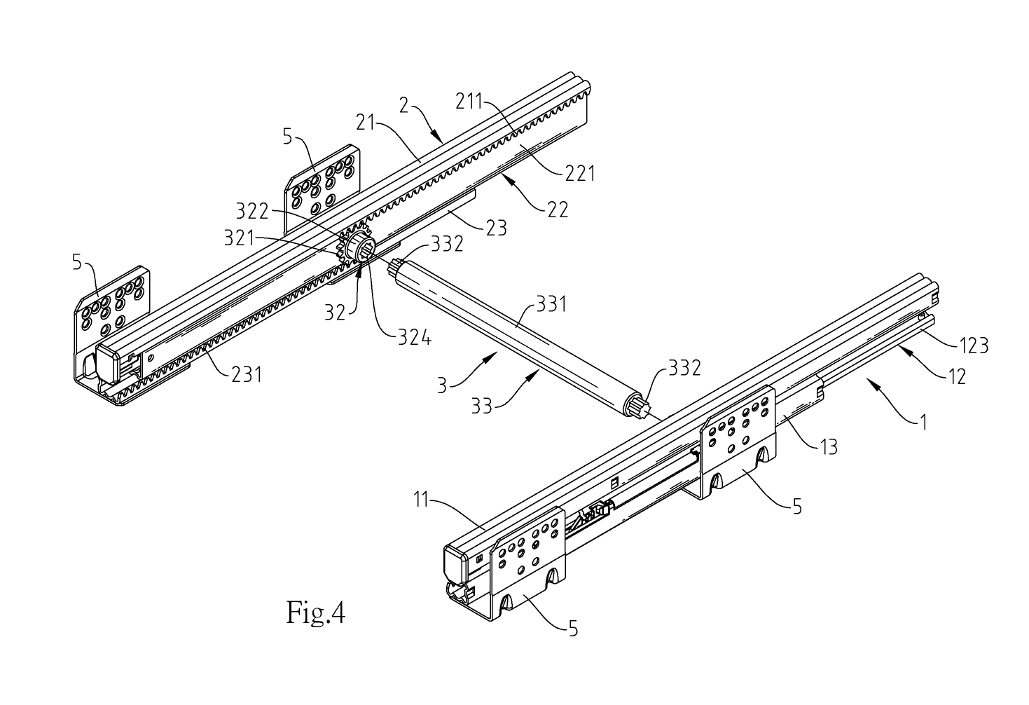

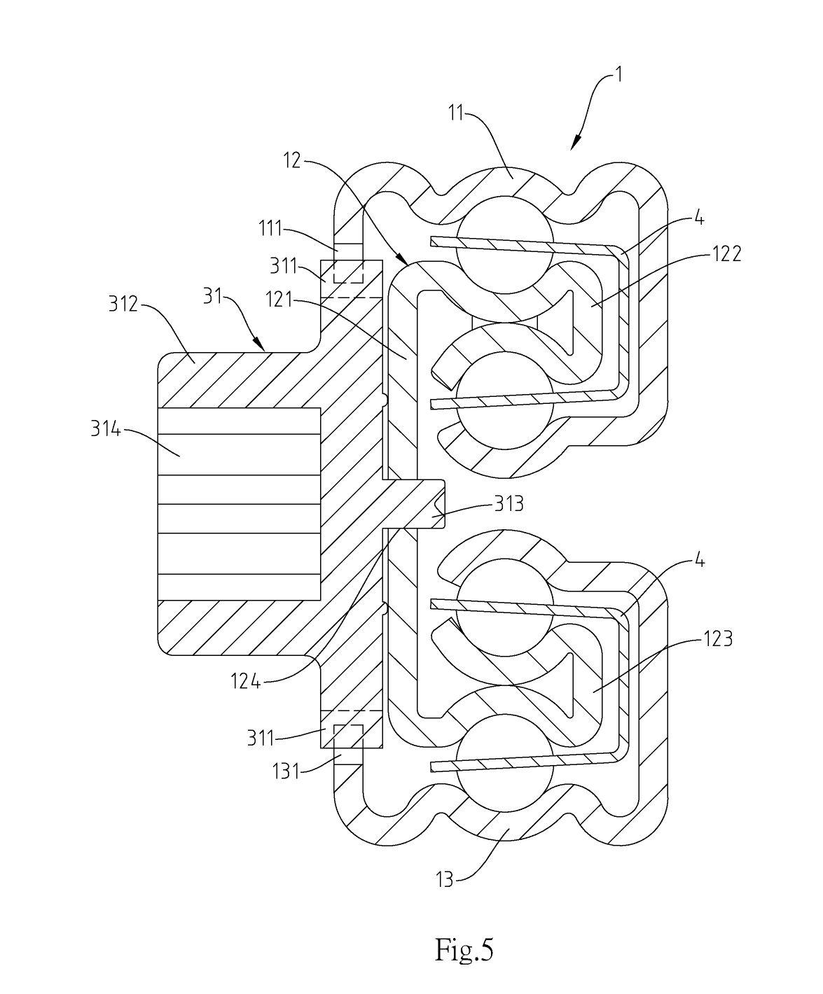

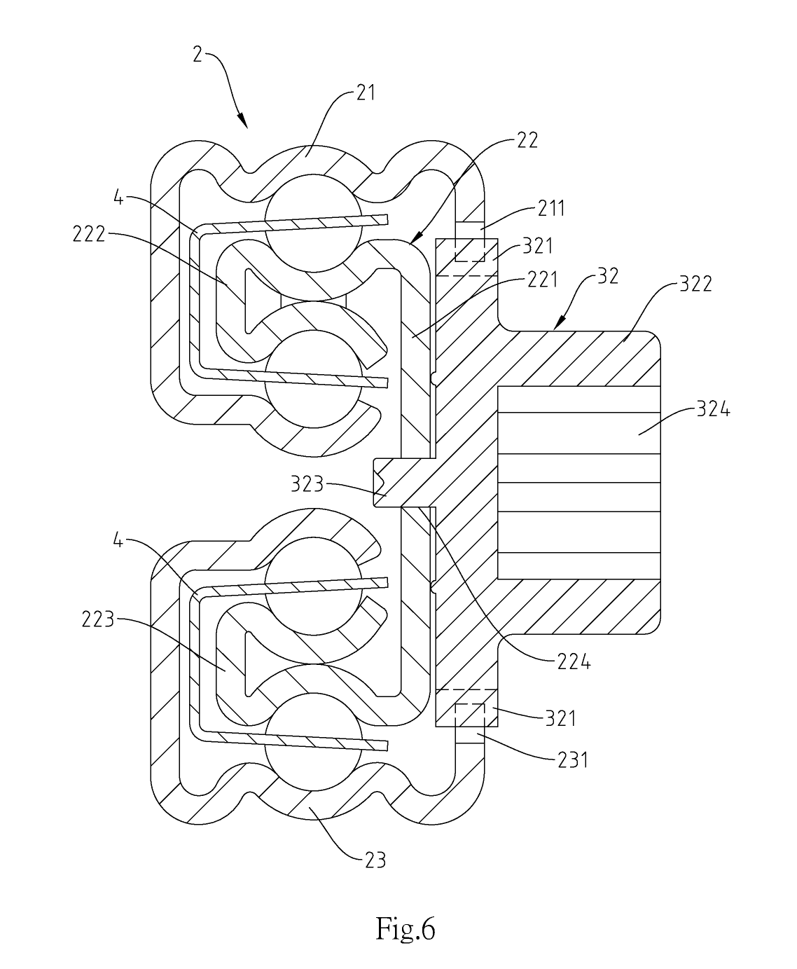

Referring to FIGS. 1-6, a synchronizing sliding rail assembly in accordance with the present invention is shown. The synchronizing sliding rail assembly comprises a first sliding rail unit 1, a second sliding rail unit 2 and a transmission mechanism 3.

The first sliding rail unit 1 comprises a first inner rail 11, a first intermediate rail 12 and a first outer rail 13. The first intermediate rail 12 comprises a first base portion 121, a first supporting portion 122 and a second supporting portion 123 respectively and transversely extended from opposing top and bottom sides of the first base portion 121, and a first pivot hole 124 located on the first base portion 121. The first inner rail 11 is connected to the first supporting portion 122 and the first outer rail 13 is connected to the second supporting portion 123, and thus, the first inner rail 11 and the first outer rail 13 are respectively disposed at opposing top and bottom sides relative to the first intermediate rail 12. Further, ball bearings 4 are respectively mounted between the first inner rail 11 and the first supporting portion 122 and between the first outer rail 13 and the second supporting portion 123. The first inner rail 11 comprises a first toothed rack 111 located at one lateral side thereof. The first outer rail 13 comprises a second toothed rack 131 located at one lateral side thereof. The first toothed rack 111 and the second toothed rack 131 are disposed at one same side relative to the first intermediate rail 12.

The second sliding rail unit 2 comprises a second inner rail 21, a second intermediate rail 22 and a second outer rail 23. The second intermediate rail 22 comprises a second base portion 221, a third supporting portion 222 and a fourth supporting portion 223 respectively and transversely extended from opposing top and bottom sides of the second base portion 221, and a second pivot hole 224 located on the second base portion 221. The second inner rail 21 is connected to the third supporting portion 222 and the second outer rail 23 is connected to the fourth supporting portion 223, and thus, the second inner rail 21 and the second outer rail 23 are respectively disposed at opposing top and bottom sides relative to the second intermediate rail 22. Further ball bearings 4 are respectively mounted between the second inner rail 21 and the third supporting portion 222 and between the second outer rail 23 and the fourth supporting portion 223. The second inner rail 21 comprises a third toothed rack 211 located at one side thereof. The second outer rail 23 comprises a fourth toothed rack 231 located at one side thereof. The third toothed rack 211 and the fourth toothed rack 231 are disposed at one same side relative to the second intermediate rail 22.

The first sliding rail unit 1 and the second sliding rail unit 2 are arranged in parallel with the first toothed rack 111 and second toothed rack 131 of the first sliding rail unit 1 respectively disposed to face toward the third toothed rack 211 and fourth toothed rack 231 of the second sliding rail unit 2.

Further, the transmission mechanism 3 comprises a first transmission member 31, a second transmission member 32 and a transmission rod 33. The first transmission member 31 comprises a first gear 311, a first pivot pin 313 located at one side of the first gear 311, a first connection block 312 located at an opposite side of the first gear 311, and a first keyway 314 located in the first connection block 312. The first pivot pin 313 is pivotally connected to the first pivot hole 124 of the first intermediate rail 12. The first gear 311 is engaged between the first toothed rack 111 and the second toothed rack 131. The second transmission member 32 comprises a second gear 321, a second pivot pin 323 and a second connection block 322 located at two opposite sides of the second gear 321, and a [symbol] second keyway 324 located in the second connection block 322. The second pivot pin 323 is pivotally connected to the second pivot hole 224 of the second intermediate rail 22. The second gear 321 is engaged between the third toothed rack 211 and the fourth toothed rack 231. The transmission rod 33 comprises a rod member 331, and two splines 332 respectively located at two opposite ends of the rod member 331. These two splines 332 are respectively engaged into the first keyway 314 and the second keyway 324.

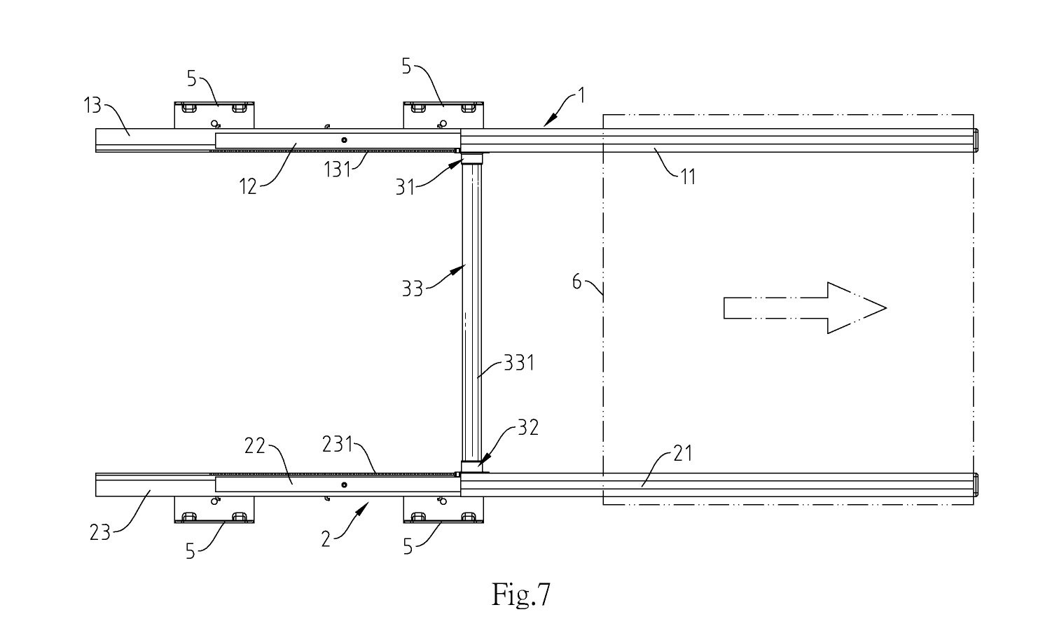

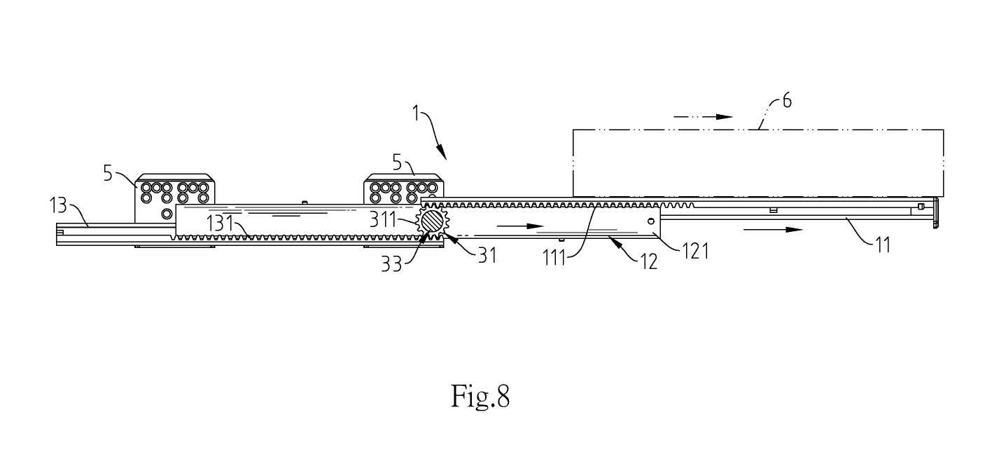

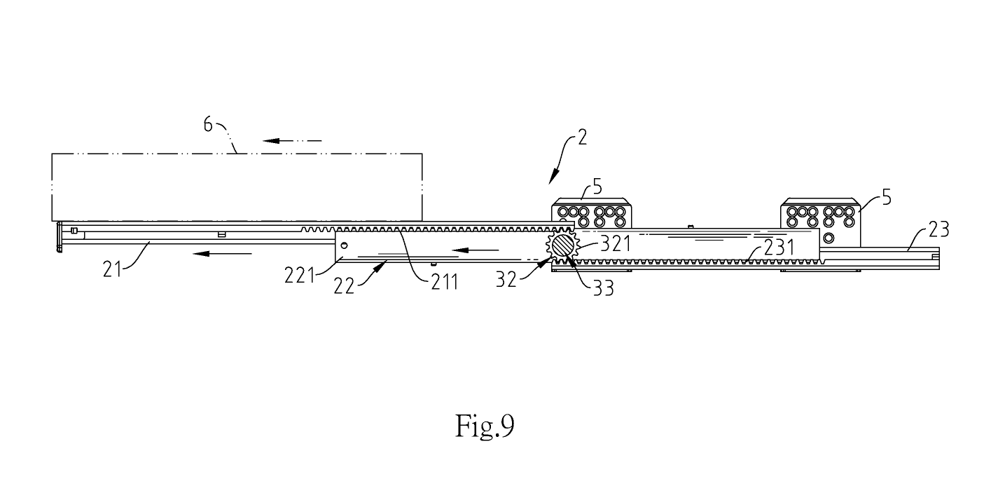

Referring to FIGS. 7-9, as illustrated, in application of the synchronizing sliding rail assembly, the first sliding rail unit 1 and the second sliding rail unit 2 are affixed to a drawer cabinet (not shown) with mounting plates 5, and a drawer 6 is connected to the first inner rail 11 and the second inner rail 21. When the user pulls the drawer 6, the first toothed rack 111 will move the first gear 311 on the second toothed rack 131 during movement of the first inner rail 11, causing the first intermediate rail 12 and the first inner rail 11 to be synchronously moved in the same direction. Because the first sliding rail unit 1 and the second sliding rail unit 2 have the same structure, displacement of the second inner rail 21 will cause the second intermediate rail 22 to move synchronously. Further, because the transmission rod 33 is coupled between the first transmission member 31 and the second transmission member 32, when the drawer 6 is being pulled or pushed by an external force, no matter whether the force is evenly or unevenly applied to the drawer, the moving distance of the first sliding rail unit 1 and the moving distance of the second sliding rail unit 2 will be constantly the same, enabling the drawer 6 to be accurately and fully opened or closed.

What the invention claimed is:

1. A synchronizing sliding rail assembly, comprising:
a first sliding rail unit, said first sliding rail unit comprising a first inner rail, a first intermediate rail and a first outer rail, said first inner rail being coupled to a top side of said first intermediate rail, said first outer rail being coupled to a bottom side of said first intermediate rail, first inner rail comprising a first toothed rack located at one side thereof, said first outer rail comprising a second toothed rack located at one side thereof, said first toothed rack and said second toothed rack being disposed at one same side relative to said first intermediate rail;
a second sliding rail unit disposed at one side relative to said first sliding rail unit, said second sliding rail unit comprising a second inner rail, a second intermediate rail and a second outer rail, said second inner rail being coupled to a top side of said second intermediate rail, said second outer rail being coupled to a bottom side of said second intermediate rail, said second inner rail comprising a third toothed rack located at one side thereof, said second outer rail comprising a fourth toothed rack located at one side thereof, said third toothed rack and said fourth toothed rack being disposed at one same side relative to said second intermediate rail;
a transmission mechanism, said transmission mechanism comprising a first transmission member, a second transmission member and a transmission rod, said first transmission member comprising a first gear pivotally connected to one side of said first intermediate rail and meshed between said first toothed rack and said second toothed rack, said first gear comprising a first connection block located at one side thereof, said second transmission member comprising a second gear pivotally connected to one side of said second intermediate rail and meshed between said third toothed rack and said fourth toothed rack, said second gear comprising a second connection block located at one side thereof, said transmission rod having two opposite ends thereof respectively connected to said first connection block and said second connection block.

2. The synchronizing sliding rail assembly as claimed in claim 1, wherein said first connection block of said first transmission member defines therein a first keyway; said second connection block of said second transmission member defines therein a second keyway; said transmission rod of said transmission mechanism comprises a rod member, and two splines respectively located at two opposite ends of said rod member and respectively engaged into said first keyway and said second keyway.

3. The synchronizing sliding rail assembly as claimed in claim 1, wherein said first intermediate rail of said first sliding rail unit comprises a first base portion, a first supporting portion and a second supporting portion respectively transversely extended from opposing top and bottom sides of said first base portion and a first pivot hole located on said first base portion; said first inner rail is connected to said first supporting portion; said first outer rail is connected to said second supporting portion; said first gear of said transmission mechanism comprises a first pivot pin located at an opposite side thereof remote from said first connection block and pivotally coupled to said first pivot hole; said second intermediate rail of said second sliding rail unit comprises a second base portion, a third supporting portion and a fourth supporting portion respectively transversely extended from opposing top and bottom sides of said second base portion and a second pivot hole located on said second base portion; said second inner rail is connected to said third supporting portion; said second outer rail is connected to said fourth supporting portion; said second gear of said transmission mechanism comprises a second pivot pin located at an opposite side thereof remote from said second connection block and pivotally coupled to said second pivot hole.
